(19) United States
(12) Patent Application Publication
(10) Pub. No.: US 2023/0337312 A1
(43) Pub. Date: Oct. 19, 2023

(54) METHOD, DEVICE AND COMPUTER READABLE MEDIUM OF COMMUNICATION FOR BEAM FAILURE RECOVERY

(71) Applicant: Nokia Technologies Oy, Espoo (FI)

(72) Inventors: Samuli TURTINEN, Ii (FI); Chunli WU, Beijing (CN); Timo KOSKELA, Oulu (FI)

(21) Appl. No.: 18/042,701

(22) PCT Filed: Aug. 24, 2020
(86) PCT No.: PCT/CN2020/110907

§ 371 Date: Feb. 23, 2023

(51) Int. Cl. H04W 76/19; H04W 36/06; H04B 7/06

(52) U.S. Cl. CPC H04W 76/19; H04W 36/06; H04B 7/0626

(57) ABSTRACT

Embodiments of the present disclosure relate to methods, devices and computer readable storage media of communication for BFR. A method implemented at a first device comprises detecting a beam failure for a serving cell of the first device; in accordance with a determination that the beam failure is detected for the serving cell, triggering a procedure for a beam failure recovery for the serving cell; determining whether information related to the beam failure recovery is available for the serving cell; and in accordance with a determination that the information is unavailable, transmitting to a second device a first indication that the beam failure is detected and a second indication that no candidate beam is available. In this way, the full BFR information for the failed serving cells can be acquired finally, and more reliable and faster BFR can be achieved.

### FIELD

Embodiments of the present disclosure generally relate to the field of telecommunication and in particular, to a method, device and computer readable storage medium of communication for beam failure recovery (BFR).

### BACKGROUND

In new radio (NR) technology, a network device may provide a plurality of serving cells for a terminal device, and the terminal device may perform a BFR procedure for each serving cell. The BFR procedure on a terminal device side usually includes the following operations: beam failure detection (BFD), a searching for a candidate beam, transmission of a BFR request to a network device and a monitoring of a response to the BFR request from the network device.

Generally, a terminal device will take several tens of milliseconds to search for a candidate beam for a serving cell where a beam failure is detected. In current BFR procedure, when a beam failure is detected on a serving cell, a terminal device transmits, to a network device, a BFR medium access control (MAC) control element (CE) to indicate the beam failure and availability of a candidate beam and the available candidate beam, if any. In case the terminal device has not completed the searching for the candidate beam at this point in time, the terminal device would need to indicate no candidates found. In this case, the network device might mistakenly deactivate the serving cell considering it as no candidates found.

### SUMMARY

In general, example embodiments of the present disclosure provide a solution for BFR.

In a first aspect, there is provided a first device. The first device comprises: at least one processor; and at least one memory including computer program code; the at least one memory and the computer program code are configured to, with the at least one processor, cause the first device to: detect, at the first device, a beam failure for a serving cell of the first device; in accordance with a determination that the beam failure is detected for the serving cell, trigger a procedure for a beam failure recovery for the serving cell; determine whether information related to the beam failure recovery is available for the serving cell; and in accordance with a determination that the information is unavailable, transmit to a second device a first indication that the beam failure is detected and a second indication that no candidate beam is available.

In a second aspect, there is provided a first device. The first device comprises: at least one processor; and at least one memory including computer program code; the at least one memory and the computer program code are configured to, with the at least one processor, cause the first device to: detect, at the first device, a beam failure for a serving cell of the first device; in accordance with a determination that the beam failure is detected for the serving cell, determine whether information related to a beam failure recovery for the serving cell is available; in accordance with a determination that the information is available, trigger a procedure for the beam failure recovery for the serving cell; and transmit to a second device a first indication that the beam failure is detected and a second indication as to whether a candidate beam is available.

In a third aspect, there is provided a second device. The second device comprises: at least one processor; and at least one memory including computer program code; the at least one memory and the computer program code are configured to, with the at least one processor, cause the second device to: perform at least one of the following: receiving, at the second device, a first indication that a beam failure for a serving cell of a first device is detected and a second indication that no candidate beam is available, the first and second indications being transmitted by the first device in accordance with a determination that information related to a beam failure recovery for the serving cell is unavailable, or receiving, at the second device, the first indication that the beam failure is detected and the second indication as to whether the candidate beam is available, the first and second indications being transmitted by the first device in accordance with a determination that the information related to the beam failure recovery for the serving cell is available; and perform beam management based on the first and second indications.

In a fourth aspect, there is provided a method of communication. The method comprises: detecting, at a first device, a beam failure for a serving cell of the first device; in accordance with a determination that the beam failure is detected for the serving cell, triggering a procedure for a beam failure recovery for the serving cell; determining whether information related to the beam failure recovery is available for the serving cell; and in accordance with a determination that the information is unavailable, transmitting to a second device a first indication that the beam failure is detected and a second indication that no candidate beam is available.

In a fifth aspect, there is provided a method of communication. The method comprises: detecting, at a first device, a beam failure for a serving cell of the first device; in accordance with a determination that the beam failure is detected for the serving cell, determining whether information related to a beam failure recovery for the serving cell is available; in accordance with a determination that the information is available, triggering a procedure for the beam failure recovery for the serving cell; and transmitting to a second device a first indication that the beam failure is detected and a second indication as to whether a candidate beam is available.

In a sixth aspect, there is provided a method of communication. The method comprises: performing at least one of the following receiving, at a second device, a first indication that a beam failure for a serving cell of a first device is detected and a second indication that no candidate beam is available, the first and second indications being transmitted by the first device in accordance with a determination that information related to a beam failure recovery for the serving cell is unavailable, or receiving, at the second device, the first indication that the beam failure is detected and the second indication as to whether the candidate beam is available, the first and second indications being transmitted by the first device in accordance with a determination that the information related to the beam failure recovery for the serving cell is available; and performing beam management based on the first and second indications.

In a seventh aspect, there is provided an apparatus of communication. The apparatus comprises: means for detecting, at a first device, a beam failure for a serving cell of the first device; means for in accordance with a determination that the beam failure is detected for the serving cell, triggering a procedure for a beam failure recovery for the serving cell; means for determining whether information related to the beam failure recovery is available for the serving cell; and means for in accordance with a determination that the information is unavailable, transmitting to a second device a first indication that the beam failure is detected and a second indication that no candidate beam is available.

In an eighth aspect, there is provided an apparatus of communication. The apparatus comprises: means for detecting, at a first device, a beam failure for a serving cell of the first device; means for in accordance with a determination that the beam failure is detected for the serving cell, determining whether information related to a beam failure recovery for the serving cell is available; means for in accordance with a determination that the information is available, triggering a procedure for the beam failure recovery for the serving cell; and means for transmitting to a second device a first indication that the beam failure is detected and a second indication as to whether a candidate beam is available.

In a ninth aspect, there is provided an apparatus of communication. The apparatus comprises: means for performing at least one of the following: receiving, at a second device, a first indication that a beam failure for a serving cell of a first device is detected and a second indication that no candidate beam is available, the first and second indications being transmitted by the first device in accordance with a determination that information related to a beam failure recovery for the serving cell is unavailable, or receiving, at the second device, the first indication that the beam failure is detected and the second indication as to whether the candidate beam is available, the first and second indications being transmitted by the first device in accordance with a determination that the information related to the beam failure recovery for the serving cell is available; and means for performing beam management based on the first and second indications.

In a tenth aspect, there is provided a non-transitory computer readable medium. The non-transitory computer readable medium comprises program instructions for causing an apparatus to perform the method according to the fourth aspect.

In an eleventh aspect, there is provided a non-transitory computer readable medium. The non-transitory computer readable medium comprises program instructions for causing an apparatus to perform the method according to the fifth aspect.

In a twelfth aspect, there is provided a non-transitory computer readable medium. The non-transitory computer readable medium comprises program instructions for causing an apparatus to perform the method according to the sixth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication network in which example embodiments of the present disclosure may be implemented;

FIG. 2 illustrates a flowchart illustrating a process of communication during a BFR procedure according to some embodiments of the present disclosure;

FIG. 3A illustrates a diagram of a BFR MAC CE according to some embodiments of the present disclosure;

FIG. 3B illustrates a diagram of another BFR MAC CE according to some embodiments of the present disclosure;

FIG. 4 illustrates a flowchart illustrating another process of communication during a BFR procedure according to some embodiments of the present disclosure;

FIG. 5 illustrates a flowchart of a method of communication implemented at a first device according to example embodiments of the present disclosure;

FIG. 6 illustrates a flowchart of another method of communication implemented at a first device according to example embodiments of the present disclosure;

FIG. 7 illustrates a flowchart of a method of communication implemented at a second device according to example embodiments of the present disclosure;

FIG. 8 illustrates a simplified block diagram of an apparatus that is suitable for implementing example embodiments of the present disclosure; and

FIG. 9 illustrates a block diagram of an example computer readable medium in accordance with example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/ or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as fifth generation (5G) systems, Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) new radio (NR) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology. A RAN split architecture comprises a gNB-CU (Centralized unit, hosting RRC, SDAP and PDCP) controlling a plurality of gNB-DUs (Distributed unit, hosting RLC, MAC and PHY). A relay node may correspond to DU part of the IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to Mobile Termination (MT) part of the integrated access and backhaul (IAB) node (a.k.a. a relay node). In the following description, the terms “terminal device”, “communication device”, “terminal”, “user equipment” and “UE” may be used interchangeably.

When a terminal device detects a beam failure on a serving cell and the terminal device has uplink-shared channel (UL-SCH) resources to transmit a BFR MAC CE, the terminal device would need to indicate beam failure as detected for the serving cell. However, in case the terminal device has not completed the candidate beam search at this point in time, the terminal device would need to indicate an availability indication (AC) field in the BFR MAC CE as no candidates found for the network device. This is the case as the Ci field setting follows the logic of beam failure is either detected or not detected for the serving cell. In case the terminal device has to always indicate no candidates found in this case, the BFR may be delayed even more compared to allowing the terminal device to complete the searching and report the candidate beam, and the network device might mistakenly deactivate the serving cell considering it as no candidates found.

In an existing solution, if the terminal device would be allowed by implementation not to indicate the serving cell as failed in case the searching is not complete, this may lead to unnecessary grants being provided by the network device to the terminal device for the failed serving cell. In case the failed serving cell is a serving cell of an uplink control channel such as PUCCH secondary cell (SCell), it may also prevent the provision of reliable downlink feedback for the SCells in the PUCCH group.

For example, Ci field interpretation is changed such that it would only indicate “beam failure detected” when set to 1 but not “beam failure not detected” when set 0 since it could be the case that beam failure is detected but candidate beam searching has not completed. However, this leads to the issue of the network device giving unnecessary grants for the failed serving cell.

Further, it has been proposed that if determining that at least one BFR has been triggered and not cancelled but no beam failure information for any serving cell is ready to report, it is not required to generate a BFR MAC CE or truncated BFR MAC CE or trigger the scheduling request (SR) for the BFR for the serving cell. However, this does not solve the issue in case there are serving cells for which candidate search has been performed already. Delaying the report after this point will delay the recovery of the given serving cells.

In view of this, embodiments of the present disclosure provide an improved solution for BFR. In the present solution, the situation that a searching for a candidate beam (also referred to as acquiring for information related to BFR herein) is still ongoing for at least one serving cell is taken into account for at least one of the BFR triggering or the reported BFR MAC CE content. In one aspect of embodiments of the present disclosure, when the BFR procedure has been triggered and there is at least one failed serving cell for which the searching has not been completed or no candidate beam has been so far detected or both, the terminal device keeps the BFR triggered and not cancelled for this serving cell so as to continue the searching until the searching is completed. In this way, the terminal device can complete the searching for the candidate beam finally and transmit full BFR information to the network device. Thus more reliable and faster BFR can be achieved.

In another aspect of embodiments of the present disclosure, a BFR for a serving cell is only triggered upon completing a searching for a candidate beam or additionally upon finding at least one suitable candidate beam for the serving cell. In this way, the network device also can get the full BFR information for the failed serving cells, and more reliable and faster BFR can also be achieved. Principles and implementations of the present disclosure will be described in detail below with reference to the figures.

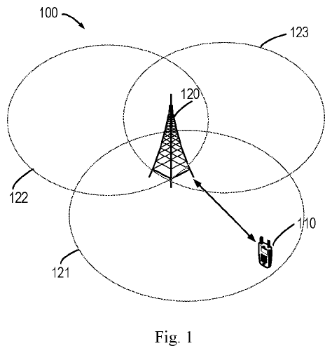

FIG. 1 illustrates an example communication network 100 in which embodiments of the present disclosure can be implemented. As shown in FIG. 1, the network 100 includes a first device 110 and a second device 120. In some embodiments, the first device 110 may be a terminal device, and the second device 120 may be a network device serving the first device 110. The second device 120 may provide serving cells 121-123 for the first device 110. For example, each of the serving cells 121-123 may be a SCell, a primary cell (PCell), a primary SCell (PSCell) or a special cell (SpCell) such as PCell or PSCell.

It is to be understood that the number and type of first and second devices and that of serving cells as shown in FIG. 1 are only for the purpose of illustration without suggesting any limitations. The network 100 may include any suitable number and type of first and second devices and that of serving cells adapted for implementing embodiments of the present disclosure.

As shown in FIG. 1, the first and second devices 110 and 120 may communicate with each other. For example, the first device 110 may detect a beam failure for each of the serving cells 121-123, and if the beam failure is detected for at least one serving cell (in this example, the serving cell 121), the first device 110 may trigger a BFR for each failed serving cell.

Upon the BFR is triggered, the first device 110 may transmit to the second device 120 an indication about the beam failure and information related to BFR for the serving cell. In some embodiments, the information related to BFR may comprise presence of candidate beam field (also referred to as Availability Indication (AC)) and/or a candidate beam ID if available for the serving cell. Of course, the information related to BFR may also comprise any other suitable information. Accordingly, the second device 120 may know the beam failure and the information related to BFR for the serving cell, and transmit to the first device 110 updated configuration for the serving cell.

The communications in the network 100 may conform to any suitable standards including, but not limited to, LTE, LTE-evolution, LTE-advanced (LTE-A), wideband code division multiple access (WCDMA), code division multiple access (CDMA) and global system for mobile communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

In some cases, when the BFR is triggered for the serving cell 121, the first device 110 may have not acquired information related to BFR for the serving cell 121. It will affect the performance of the BFR and thus should be considered. The BFR information acquisition or the candidate search may comprise, for instance, evaluating of a beam (such as synchronization signal and physical broadcast channel (PBCH) block (SSB) beam or channel state information-reference signal (CSI-RS) beam) for a pre-defined time period. In some cases, the BFR information becomes available when the beam is better than a configured threshold value.

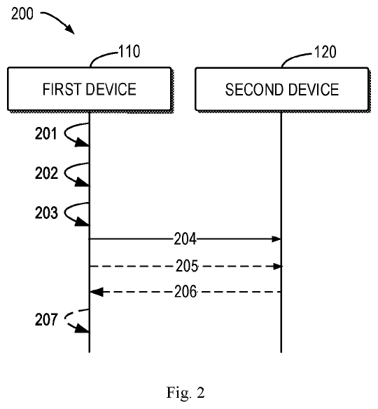

In view of this, embodiments of the present disclosure provide a solution for BFR, the mechanism of which is illustrated in a high-level flowchart as shown in FIG. 2. FIG. 2 illustrates a flowchart 200 illustrating a process of communication for BFR according to some embodiments of the present disclosure. For convenience, FIG. 2 will be described in connection with the example of FIG. 1.

As shown in FIG. 2, the first device 110 detects 201 a beam failure for each of the serving cells 121-123. In some embodiments, if beam failure instance indication has been received from lower layers, the first device 110 may start or restart a timer for BFD (for example, beamFailureDetectionTimer), and increment a value of a counter (for example, BFI_COUNTER) by 1. Of course, any other suitable ways are also feasible for BFD, and the present disclosure does not make limitation for this.

If the first device 110 detects the beam failure for the serving cell 121, the first device 110 triggers 202 a BFR procedure for the serving cell 121. Following the above example, if the value of the counter is above a threshold (for example, beamFailureInstanceMaxCount), the first device 110 may trigger the BFR procedure for the serving cell 121. It should be noted that this is merely an example, and any other suitable ways are also feasible to trigger a BFR procedure.

Upon triggering the BFR procedure or during the BFR procedure, the first device 110 may determine 203 whether information related to BFR is available for the serving cell 121. In some embodiments, the first device 110 may perform this determination by determining whether a searching for a candidate beam for the serving cell 121 is completed. In some embodiments, if determining that the searching is not completed, the first device 110 may determine that the information related to BFR is unavailable. In some embodiments, if determining that the searching is completed, the first device 110 may determine that the information related to BFR is available.

In some embodiments, the first device 110 may determine whether the searching is completed by determining whether at least one candidate beam is identified within a predetermined period. In some embodiments, if determining that the at least one candidate beam is identified within the predetermined period, the first device 110 may determine that the searching is completed.

In some embodiments, the first device 110 may determine whether the searching is completed by determining whether no candidate beam is identified within the predetermined period. In some embodiments, if determining that no candidate beam is identified within the predetermined period, the first device 110 may determine that the searching is completed.

In some embodiments, the predetermined period may be set for candidate beam evaluation, for example, for synchronization signal and physical broadcast channel (PBCH) block (SSB)/channel state information-reference signal (CSI-RS). Of course, the predetermined period may be in any other suitable ways.

In some embodiments, the first device 110 may identify or find the candidate beam from a resource set (also referred to as a first resource set herein) configured for the searching. In some embodiments, the first resource set may be a set of RSs configured for candidate beam evaluation. For example, if at least one of the SSBs with SS-RSRP above rsrp-ThresholdBFR amongst the SSBs in candidateBeamRSSCellList or the CSI-RSs with CSI-RSRP above rsrp-ThresholdBFR amongst the CSI-RSs in candidateBeamRSSCellList is available, the first device 110 may determine that the candidate beam is found, and then determine that the searching is completed. It should be noted that this is merely an example, and does not make limitation for the present disclosure.

In some embodiments, if no candidate beam is found from the first resource set, the first device 110 may continue the searching in another resource set (also referred to as a second resource set herein) configured for the serving cell 121. For example, when no candidate beam is found and the candidate beam evaluation period is completed, the first device 110 may keep the BFR triggered and consider one or more or all the SSB indices (and/or CSI-RS indices) configured for the serving cell (or for the serving cell that the device 110 determines at least one set of candidates) 121 as the second resource set. In this case, the first device 110 may initiate a new evaluation period. If the candidate beam is found from the second resource set, the first device 110 may determine that the candidate beam is found, and then determine that the searching is completed. In some examples, the second resource set may be determined on the resource of same serving cell where the first resource set is configured or the second resource set may be determined on the resources configured for another serving cell (e.g. PCell or SCell SSB indices and/or CSI-RS indices).

In some embodiments, the first device 110 may determine whether the first resource set comprises the second resource set. If determining that the first resource set comprises the second resource set, the first device 110 may does not keep or remain the BFR triggered. That is, it is unnecessary to continue the searching in the second resource set. If determining that the first resource set does not comprise (for example, comprises only partly) the second resource set, the first device 110, the first device 110 may continue the searching in the second resource set.

In these embodiments, the second device 120 may know that the first device 110 now considers the SSB indices after provision of BFR MAC CE with the indication that search period has been completed and is able to decode the candidate RS field with SSB indices only in the subsequent transmissions concerning the serving cell 121.

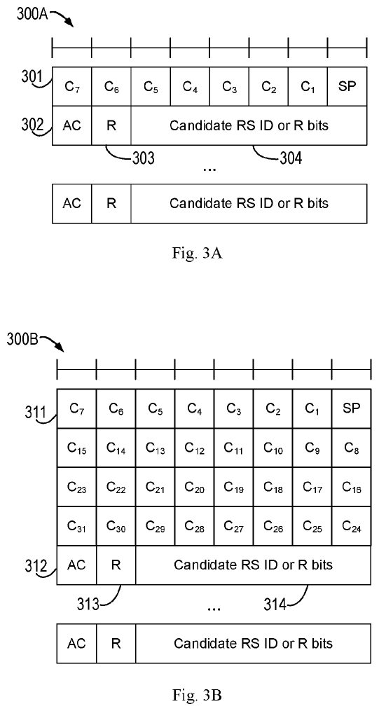

So far, the description is made on the determination about whether information related to BFR is available for the serving cell 121. If the first device 110 determines that the information related to BFR is unavailable for the serving cell 121, the first device 110 transmits 204 to the second device 120 a first indication that the beam failure is detected and a second indication that no candidate beam is available. In some embodiments, the first device 110 may generate a BFR MAC CE to carry the first and second indications. FIG. 3A illustrates a diagram 300A of a BFR MAC CE with the highest ServCellIndex less than 8. FIG. 3B illustrates a diagram 300B of a BFR MAC CE with the highest ServCellIndex equal to or higher than 8. Of course, any other suitable forms of a BFR MAC CE are also feasible.

For example, one field in the BFR MAC CE (for example, Cᵢ field 301 in FIG. 3A or Cᵢ field 311 in FIG. 3B) may be used to indicate beam failure detection for the serving cell, and another field in the BFR MAC CE (for example, AC field 302 in FIG. 3A or AC field 312 in FIG. 3B) may be used to indicate the presence of a candidate beam. As an example, Cᵢ field for serving cell 121 may be set as 1 to indicate that the beam failure is detected, and the Cᵢ field may be set as 0 to indicate that the beam failure is not detected for serving cell with cell ID i. As an example, AC field for serving cell 121 may be set as 1 to indicate that the candidate beam is available, and the AC field may be set as 0 to indicate that the candidate beam is unavailable. Of course, these are merely examples, and the first and second indications also can be transmitted in any other suitable ways.

In some embodiments, the first device 110 may also transmit to the second device 120 a third indication as to whether the searching is completed. For example, one field in the BFR MAC CE (for example, R field 303 in FIG. 3A or R field 313 in FIG. 3B) may be used to indicate whether the searching is completed. This indication may be one bit flag. The interpretation of the R field can also be that the BFR MAC CE does or does not include the full BFR information for the serving cell 121. Accordingly, the second device 120 may determine based on the R field that the first device 110 is still searching for candidates and more information can follow and hence would not necessarily perform any beam management actions for the serving cell 121.

In some alternative embodiments, if the AC field in the BFR MAC CE is set to indicate no candidate beam found (for example, is set to 0), one or more bits of the candidate RS index field 304 in FIG. 3A or 314 in FIG. 3B may be used to encode indication whether the searching is completed. In some embodiments, completion of the searching may indicate whether the first device 110 has searched for candidate beams according to the minimum candidate beam search, i.e., candidate beam evaluation period requirement.

Of course, these are merely examples, and the third indication also can be transmitted in any other suitable ways, and the present disclosure does not make limitation for this.

In these embodiments, when the first and second indications are transmitted, the first device 110 may remain the BFR for the serving cell 121 triggered and not cancelled. In this case, the searching for a candidate beam can be continued until the searching is completed. Thereby, the searching for a candidate beam can be completed and the candidate beam if present may be further indicated via a separate BFR MAC CE.

With reference to FIG. 2, in some embodiments, when the first device 110 determines that the information related to BFR is available for the serving cell 121, for example, when the first device 110 determines that the searching is completed, the first device 110 may retransmit 205 the first and second indications to the second device 120. For example, the first device 110 may generate a new BFR MAC CE to carry the first and second indications. The first indication indicates the beam failure for serving cell 121. The second indication indicates whether the information related to BFR is available. In this case, regardless of if the first device 110 is able to find a candidate beam or not, the first device 110 is required to transmit the BFR MAC CE again to the second device 120.

In some embodiments where the candidate beam is found, the first device 110 may also transmit information about the candidate beam. For example, the first device 110 may transmit the candidate beam RS ID in candidate RS index field 304 in FIG. 3A or 314 in FIG. 3B. Of course, any other suitable ways are also feasible.

In some alternative embodiments, in case no new candidate beam is found, the first device 110 may cease from reporting a new BFR MAC CE.

With reference to FIG. 2, in some embodiments where the BFR procedure is kept triggered for the serving cell 121 and the first device 110 indicates no candidate beam found, the second device 120 may take beam management actions accordingly. In some embodiments, the second device 120 may transmit 206 an updated or new configuration for a reporting of a CSI measurement. In some embodiments, the second device 120 may transmit an updated configuration for a measurement of CSI. In some embodiments, the second device 120 may transmit a condition for a reporting of CSI. In some embodiments, the second device 120 may transmit a beam indication for a downlink control channel for the serving cell 121.

For example, if the first device 110 has sent a BFR MAC CE to the second device 120 indicating no candidate has been found after the candidate beam evaluation period or the searching is not completed and the BFR is kept triggered, the second device 120 may transmit such information to perform beam management. It should be noted that any other suitable information is also feasible and does not limited to the above examples.

In these embodiments, upon receiving the information from the second device 120, the first device 110 may cease 207 the searching for a candidate beam, and then the BFR procedure is cancelled for the serving cell 121.

With the process described in FIG. 2, in case a searching for a candidate beam for a serving cell is not completed, a BFR can be triggered and kept triggered until the searching is completed. Meanwhile, one or more BFR MAC CEs can be transmitted to convey the full BFR information for the failed serving cell. In this way, the network device can finally get the full BFR information for the failed serving cells in a BFR MAC CE, and more reliable and faster BFR can be achieved.

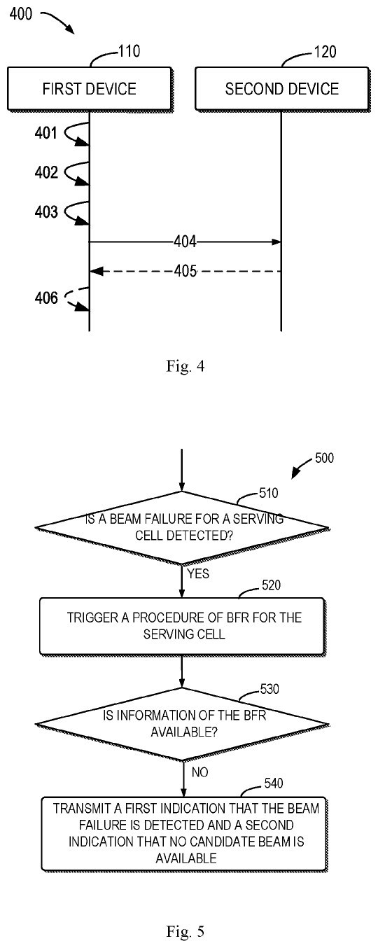

Embodiments of the present disclosure also provide another solution for BFR, the mechanism of which is illustrated in a high-level flowchart as shown in FIG. 4. FIG. 4 illustrates a flowchart 400 illustrating a process of communication for BFR according to some embodiments of the present disclosure. For convenience, FIG. 4 will be described in connection with the example of FIG. 1. In contrast to FIG. 2, the idea of the process in FIG. 4 is in that a BFR can only be triggered for a serving cell when a searching for a candidate beam for the serving cell is completed.

As shown in FIG. 4, the first device 110 detects 401 a beam failure for each of the serving cells 121-123. The operation of the detection is similar with that described in connection with 201 in FIG. 2, and thus is not repeated here for concise.

If the first device 110 detects the beam failure for the serving cell 121, the first device 110 determines 402 whether information related to BFR for the serving cell 121 is available. The operation of the determination is similar with that described in connection with 203 in FIG. 2, and thus is not repeated here for concise.

If determining that the information related to BFR for the serving cell 121 is available, the first device 110 triggers 403 a procedure for the BFR for the serving cell 121. The operation of the trigger is similar with that described in connection with 202 in FIG. 2, and thus is not repeated here for concise.

Upon the BFR procedure is triggered, the first device 110 transmits 404 to the second device 120 a first indication that the beam failure is detected and a second indication as to whether a candidate beam is available.

In some embodiments, the first device 110 may generate a BFR MAC CE to carry the first and second indications. For example, one field in the BFR MAC CE (for example, Cᵢ field 301 in FIG. 3A or Cᵢ field 311 in FIG. 3B) may be used to indicate BFD, and another field in the BFR MAC CE (for example, AC field 302 in FIG. 3A or AC field 312 in FIG. 3B) may be used to indicate the presence of candidate beam. As an example, Cᵢ field for serving cell 121 may be set as 1 to indicate that the beam failure is detected, and the Cᵢ field may be set as 0 to indicate that the beam failure is detected. As an example, AC field for serving cell 121 may be set as 1 to indicate that the candidate beam is available, and the AC field may be set as 0 to indicate that the candidate beam is unavailable. Of course, these are merely examples, and the first and second indications also can be transmitted in any other suitable ways.

In some embodiments where the candidate beam is found, the first device 110 may also transmit information about the candidate beam. For example, the first device 110 may transmit the candidate beam RS ID in candidate RS index field 304 in FIG. 3A or 314 in FIG. 3B. Of course, any other suitable ways are also feasible.

With reference to FIG. 4, in some embodiments, the second device 120 may transmit 405 information about at least one of the following: an updated configuration for a reporting of a CSI measurement, an updated configuration for a measurement of CSI, a condition for a reporting of CSI, or a beam indication for a downlink control channel for the serving cell 121. For example, if the first device 110 has sent a BFR MAC CE to the second device 120 indicating no candidate has been found after the candidate beam evaluation period or the searching is not completed and the BFR is kept triggered, the second device 120 may transmit such information to perform beam management.

In these embodiments, upon receiving the information from the second device 120, the first device 110 may cease 406 the searching for a candidate beam, and then the BFR procedure is cancelled for the serving cell 121.

With the process described in FIG. 4, a BFR can be triggered only in case a searching for a candidate beam for a serving cell is completed. In this way, the network device can get the full BFR information for the failed serving cells in a BFR MAC CE, and more reliable and faster BFR can be achieved.

Corresponding to the above processes, some example embodiments of the present disclosure will now be described in detail with reference to the figures. However, those skilled in the art would readily appreciate that the detailed description given herein with respect to these figures is for explanatory purpose as the present disclosure extends beyond theses limited embodiments.

FIG. 5 illustrates a flowchart of a method 500 of communication implemented at a first device according to example embodiments of the present disclosure. The method 500 can be implemented at the first device 110 shown in FIG. 1. For the purpose of discussion, the method 500 will be described with reference to FIG. 1. It is to be understood that method 500 may further include additional blocks not shown and/or omit some shown blocks, and the scope of the present disclosure is not limited in this regard.

As shown in FIG. 5, at block 510, the first device 110 detects a beam failure for the serving cell 121 of the first device 110. In some embodiments, if beam failure instance indication has been received from lower layers, the first device 110 may start or restart a timer for BFD (for example, beamFailureDetectionTimer), and increment a value of a counter (for example, BFI_COUNTER) by 1. Of course, any other suitable ways are also feasible for BFD, and the present disclosure does not make limitation for this. In some embodiments, if the value of the counter is above a threshold (for example, beamFailureInstanceMaxCount), the first device 110 may determine that the beam failure is detected for the serving cell. It should be noted that this is merely an example, and any other suitable ways for BFD are also feasible.

If the first device 110 detects the beam failure for the serving cell 121, at block 520, the first device 110 triggers a BFR procedure for the serving cell 121. The trigger of the BFR procedure means start of operations of blocks 530-540.

At block 530, the first device 110 determines whether information related to BFR is available for the serving cell 121. In some embodiments, the first device 110 may determine whether a searching for a candidate beam for the serving cell is completed. If determining that the searching is not completed, the first device 110 may determine that the information is unavailable. If determining that the searching is completed, the first device 110 may determine that the information is available.

In some embodiments, if determining that at least one candidate beam is identified within a predetermined period, the first device 110 may determine that the search is completed. In some embodiments, if determining that no candidate beam is identified within the predetermined period, the first device 110 may determine that the search is completed.

If determining that the information is unavailable, at block 540, the first device 110 transmits to the second device 120 a first indication that the beam failure is detected and a second indication that no candidate beam is available. In some embodiments, if determining that the information is unavailable, the first device 110 may remain the procedure for the BFR for the serving cell 121 triggered. In this way, a searching for a candidate beam can be continued and then completed. Thus, full information related to BFR can be available and the performance of the BFR procedure is facilitated.

In some embodiments, the first device 110 may also transmit to the second device 120 a third indication as to whether the searching is completed. In this way, the second device 120 may know that the first device 110 is still searching for candidates and more information can follow and hence would not necessarily perform any beam management actions for the serving cell 121.

In some embodiments where the procedure for the BFR for the serving cell 121 is kept triggered, if the searching is completed such that the information related to BFR is available, the first device 110 may transmit to the second device 120 the first indication that the beam failure is detected and the second indication as to whether the candidate beam is available again. In this way, full BFR information can be transmitted to the second device 120 finally.

In some embodiments where a searching for a candidate beam is completed for the serving cell 121, the first device 110 may determine whether the candidate beam is found. If determining that no candidate beam is found from a first resource set configured for the searching, the first device 110 may continue the searching in a second resource set configured for the serving cell. If determining that the candidate beam is found from the second resource set, the first device may determine that the candidate beam is found. In this way, a full BFR information can be acquired more reliably.

In some embodiments, the first device 110 may determine whether a first resource set configured for the searching comprises a second resource set configured for the serving cell. If determining that the first resource set does not comprise the second resource set, the first device 110 may continue the searching in the second resource set. In this way, the searching can be carried out more effectively.

In some embodiments, if determining that the candidate beam is found, the first device 110 may transmit the second indication that the candidate beam is available. In some embodiments, the first device 110 may also transmit to the second device 120 information about the candidate beam.

In some embodiments, the first device 110 may cease the searching in response to receiving from the second device 120 information about at least one of the following: an updated configuration for a reporting of a CSI measurement, an updated configuration for a measuring of CSI, a condition for a reporting of CSI, or a beam indication for a downlink control channel for the serving cell 121.

The operations in the method of FIG. 5 correspond to that in the process described in FIG. 2, and thus other details are omitted here for concise. With the method of FIG. 5, in case the searching for a candidate beam has not been completed for a serving cell, a BFR can be triggered and kept triggered until the searching is completed. Meanwhile, one or more BFR MAC CEs can be transmitted to convey the full BFR information for the failed serving cell. In this way, the full BFR information for the failed serving cells can be acquired finally, and more reliable and faster BFR can be achieved.

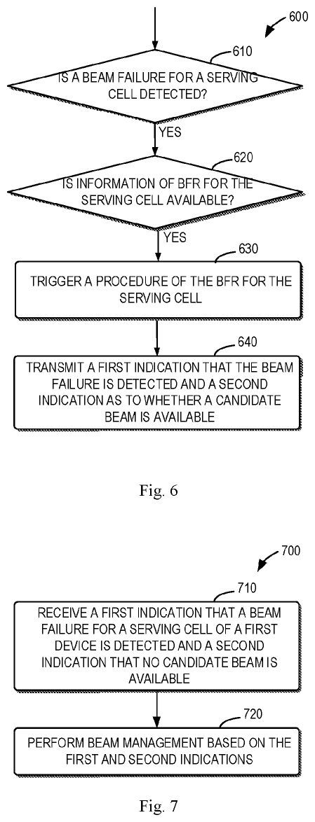

FIG. 6 illustrates a flowchart of another method 600 of communication implemented at a first device according to example embodiments of the present disclosure. The method 600 can be implemented at the first device 110 shown in FIG. 1. For the purpose of discussion, the method 600 will be described with reference to FIG. 1. It is to be understood that method 600 may further include additional blocks not shown and/or omit some shown blocks, and the scope of the present disclosure is not limited in this regard.

As shown in FIG. 6, at block 610, the first device 110 detects a beam failure for the serving cell 121 of the first device 110. In some embodiments, if beam failure instance indication has been received from lower layers, the first device 110 may start or restart a timer for BFD (for example, beamFailureDetectionTimer), and increment a value of a counter (for example, BFI_COUNTER) by 1. Of course, any other suitable ways are also feasible for BFD, and the present disclosure does not make limitation for this. In some embodiments, if the value of the counter is above a threshold (for example, beamFailureInstanceMaxCount), the first device 110 may determine that the beam failure is detected for the serving cell. It should be noted that this is merely an example, and any other suitable ways for BFD are also feasible.

If the first device 110 detects the beam failure for the serving cell 121, at block 620, the first device 110 determines whether information related to BFR for the serving cell 121 is available. In some embodiments, the first device 110 may determine whether a searching for a candidate beam for the serving cell is completed. If determining that the searching is not completed, the first device 110 may determine that the information is unavailable. If determining that the searching is completed, the first device 110 may determine that the information is available.

In some embodiments, if determining that at least one candidate beam is identified within a predetermined period, the first device 110 may determine that the search is completed. In some embodiments, if determining that no candidate beam is identified within the predetermined period, the first device 110 may determine that the search is completed.

If determining that the information is available, at block 630, the first device 110 triggers a BFR procedure for the serving cell 121. The trigger of the BFR procedure means start of the operation of block 640.

At block 640, the first device 110 transmits to the second device 120 a first indication that the beam failure is detected and a second indication as to whether a candidate beam is available. In this way, full BFR information can be transmitted to the second device 120.

In some embodiments, the first device 110 may determine whether the candidate beam is found. If determining that no candidate beam is found from a first resource set configured for the searching, the first device 110 may continue the searching in a second resource set configured for the serving cell. If determining that the candidate beam is found from the second resource set, the first device 110 may determine that the candidate beam is found. In this way, a full BFR information can be acquired more reliably.

In some embodiments, the first device 110 may determine whether the first resource set comprises the second resource set. If determining that the first resource set does not comprise the second resource set, the first device 110 may continue the searching in the second resource set. In this way, the searching can be carried out more effectively.

In some embodiments, if determining that the candidate beam is found, the first device 110 may transmit the second indication that the candidate beam is available. In some embodiments, the first device 110 may also transmit to the second device 120 information about the candidate beam.

In some embodiments, the first device 110 may cease the searching in response to receiving from the second device 120 information about at least one of the following: an updated configuration for a reporting of a CSI measurement, an updated configuration for a measuring of CSI, a condition for a reporting of CSI, or a beam indication for a downlink control channel for the serving cell 121.

The operations in the method of FIG. 6 correspond to that in the process described in FIG. 4, and thus other details are omitted here for concise. With the method of FIG. 6, a BFR can be triggered only in case a searching for a candidate beam for a serving cell is completed. In this way, full BFR information for the failed serving cells can be conveyed to the network device, and more reliable and faster BFR also can be achieved.

It should be noted that each of the methods of FIGS. 5 and 6 can be used separately. Of course, the method of FIG. 5 and that of FIG. 6 can be used jointly in any suitable ways.

Correspondingly, embodiments of the present disclosure also provide a method of communication implemented at a second device. FIG. 7 illustrates a flowchart of a method 700 of communication implemented at a second device according to example embodiments of the present disclosure. The method 700 can be implemented at the second device 120 shown in FIG. 1. For the purpose of discussion, the method 700 will be described with reference to FIG. 1. It is to be understood that method 700 may further include additional blocks not shown and/or omit some shown blocks, and the scope of the present disclosure is not limited in this regard.

As shown in FIG. 7, at block 710, the second device 120 performs at least one of the following: receiving a first indication that a beam failure for the serving cell 121 of the first device 110 is detected and a second indication that no candidate beam is available, the first and second indications being transmitted by the first device 110 in accordance with a determination that information related to a BFR for the serving cell 121 is unavailable; or receiving the first indication that the beam failure is detected and the second indication as to whether the candidate beam is available, the first and second indications being transmitted by the first device 110 in accordance with a determination that the information related to the beam failure recovery for the serving cell 121 is available.

In some embodiments, if a searching for a candidate beam is not completed for the serving cell 121 by the first device 110, the second device 120 may receive a first indication that a beam failure for the serving cell 121 of the first device 110 is detected and a second indication that no candidate beam is available. In some embodiments, the second device 120 may also receive a third indication as to whether the searching is completed. Based on the third indication, the second device 120 can know whether the searching is completed, and can decide whether to take any beam management actions.

In these embodiments, when a searching for a candidate beam is finally completed for the serving cell 121 by the first device 110, the second device 120 may further receive the first indication that a beam failure for the serving cell 121 of the first device 110 is detected and the second indication as to whether the candidate beam is available. In this way, the second device 120 can get full BFR information for the serving cell 121.

In some embodiments where the second indication indicates that the candidate beam is available, the second device 120 may also receive information about the candidate beam from the first device 110.

At block 720, the second device 120 performs beam management based on the first and second indications. In some embodiments, the second device 120 may determine, from the first and second indications, whether the beam failure is detected for the serving cell 121 and whether a candidate beam is available. The second device 120 may take beam management actions accordingly. In some embodiments, the second device 120 may transmit information about at least one of the following to the first device 110 so that a searching for the candidate beam is ceased: an updated configuration for a reporting of a CSI measurement, an updated configuration for a measurement of CSI, a condition for a reporting of CSI, or a beam indication for a downlink control channel for the serving cell 121.

With the method of FIG. 7, the network device can get full BFR information for the failed serving cells, and more reliable and faster BFR can be achieved.

In some embodiments, an apparatus (for example, the first device 110) capable of performing the method 500 may comprise means for performing the respective steps of the method 500. The means may be implemented in any suitable form. For example, the means may be implemented in a circuitry or software module.

In some embodiments, the apparatus may comprise: means for detecting, at a first device, a beam failure for a serving cell of the first device; means for in accordance with a determination that the beam failure is detected for the serving cell, triggering a procedure for a beam failure recovery for the serving cell; means for determining whether information related to the beam failure recovery is available for the serving cell; and means for in accordance with a determination that the information is unavailable, transmitting to a second device a first indication that the beam failure is detected and a second indication that no candidate beam is available.

In some embodiments, the apparatus may further comprise: means for remaining the procedure for the beam failure recovery for the serving cell triggered in accordance with a determination that the information is unavailable.

In some embodiments, the means for determining may comprise means for determining whether a searching for a candidate beam for the serving cell is completed; means for in accordance with a determination that the searching is not completed, determining that the information is unavailable; and means for in accordance with a determination that the searching is completed, determining that the information is available.

In some embodiments, the means for determining whether the searching is completed may comprise: means for in accordance with a determination that at least one candidate beam is identified within a predetermined period, determining that the search is completed; or means for in accordance with a determination that no candidate beam is identified within the predetermined period, determining that the search is completed.

In some embodiments, the apparatus may further comprise: means for transmitting to the second device a third indication as to whether the searching is completed.

In some embodiments, the apparatus may further comprise: means for in accordance with a determination that the information is available, transmit to the second device the first indication that the beam failure is detected and the second indication as to whether the candidate beam is available.

In some embodiments, the means for transmitting may comprise: means for determining whether the candidate beam is found; and means for in accordance with a determination that the candidate beam is found, transmitting the second indication that the candidate beam is available. In these embodiments, the apparatus further comprises means for transmitting to the second device information about the candidate beam.

In some embodiments, the means for determining whether the candidate beam may comprise: means for in accordance with a determination that no candidate beam is found from a first resource set configured for the searching, continuing the searching in a second resource set configured for the serving cell; and means for in accordance with a determination that the candidate beam is found from the second resource set, determining that the candidate beam is found.

In some embodiments, the means for continuing may comprise: means for determining whether a first resource set configured for the searching comprises a second resource set configured for the serving cell; and means for in accordance with a determination that the first resource set does not comprise the second resource set, continuing the searching in the second resource set.

In some embodiments, the apparatus may further comprise: means for ceasing the searching in response to receiving from the second device information about at least one of the following: an updated configuration for a reporting of a channel state information measurement, an updated configuration for a measurement of channel state information, a condition for a reporting of channel state information, or a beam indication for a downlink control channel for the serving cell.

In some embodiments, an apparatus (for example, the first device 110) capable of performing the method 600 may comprise means for performing the respective steps of the method 600. The means may be implemented in any suitable form. For example, the means may be implemented in a circuitry or software module.

In some embodiments, the apparatus may comprise: means for detecting, at a first device, a beam failure for a serving cell of the first device; means for in accordance with a determination that the beam failure is detected for the serving cell, determining whether information related to a beam failure recovery for the serving cell is available; means for in accordance with a determination that the information is available, triggering a procedure for the beam failure recovery for the serving cell; and means for transmitting to a second device a first indication that the beam failure is detected and a second indication as to whether a candidate beam is available.

In some embodiments, the means for determining whether the information is available for the serving cell may comprise: means for determining whether a searching for a candidate beam for the serving cell is completed; means for in accordance with a determination that the searching is not completed, determining that the information is unavailable; and means for in accordance with a determination that the searching is completed, determining that the information is available.

In some embodiments, the means for determining whether the searching is completed comprises: means for in accordance with a determination that at least one candidate beam is identified within a predetermined period, determining that the search is completed; or means for in accordance with a determination that no candidate beam is identified within the predetermined period, determining that the search is completed.

In some embodiments, the means for transmitting the second indication comprises: means for determining whether the candidate beam is found; and means for in accordance with a determination that the candidate beam is found, transmitting the second indication that the candidate beam is available. In these embodiments, the apparatus may further comprise: means for transmitting, to the second device, information about the candidate beam.

In some embodiments, the means for determining whether the candidate beam is found may comprise: means for in accordance with a determination that no candidate beam is found from a first resource set configured for the searching, continuing the searching in a second resource set configured for the serving cell; and means for in accordance with a determination that the candidate beam is found from the second resource set, determining that the candidate beam is found.

In some embodiments, the means for continuing the searching in the second resource set may comprise: means for determining whether a first resource set configured for the searching comprises a second resource set configured for the serving cell; and means for in accordance with a determination that the first resource set does not comprise the second resource set, continuing the searching in the second resource set.

In some embodiments, the apparatus may further comprise: means for ceasing the searching in response to receiving from the second device information about at least one of the following: an updated configuration for a reporting of a channel state information measurement, an updated configuration for a measurement of channel state information, a condition for a reporting of channel state information, or a beam indication for a downlink control channel for the serving cell.

In some embodiments, an apparatus (for example, the second device 120) capable of performing the method 700 may comprise means for performing the respective steps of the method 700. The means may be implemented in any suitable form. For example, the means may be implemented in a circuitry or software module.

In some embodiments, the apparatus may comprise: means for performing at least one of the following: receiving a first indication that a beam failure for a serving cell of a first device is detected and a second indication that no candidate beam is available, the first and second indications being transmitted by the first device in accordance with a determination that information related to a beam failure recovery for the serving cell is unavailable; or receiving the first indication that the beam failure is detected and the second indication as to whether the candidate beam is available, the first and second indications being transmitted by the first device in accordance with a determination that the information related to the beam failure recovery for the serving cell is available; and means for performing beam management based on the first and second indications.

In some embodiments, the apparatus may further comprise: means for receiving from the first device a third indication as to whether a searching for the candidate beam is completed.

In some embodiments where the second indication indicates that the candidate beam is available, the apparatus may further comprise means for receiving from the first device information about the candidate beam.

In some embodiments, the apparatus may further comprise: means for transmitting information about at least one of the following to the first device so that a searching for the candidate beam is ceased: an updated configuration for a reporting of a channel state information measurement, an updated configuration for a measurement of channel state information, a condition for a reporting of channel state information, or a beam indication for a downlink control channel for the serving cell.

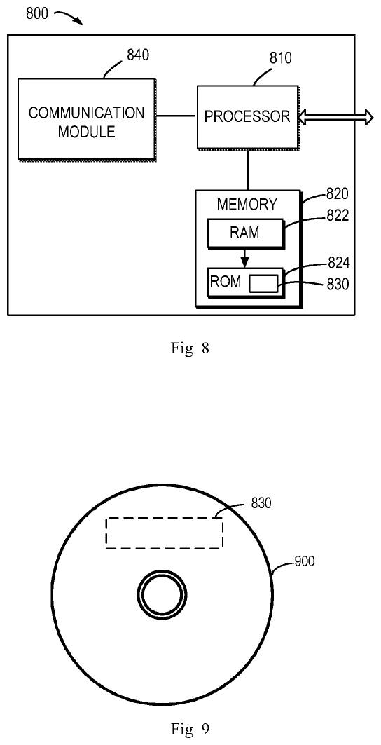

FIG. 8 is a simplified block diagram of a device 800 that is suitable for implementing embodiments of the present disclosure. The device 800 may be provided to implement the first device or the second device, for example the first device 110 or the second device 120 as shown in FIG. 1. As shown, the device 800 includes one or more processors 810, one or more memories 820 coupled to the processor 810, and one or more communication modules 840 (such as, transmitters and/or receivers) coupled to the processor 810.

The communication module 840 is for bidirectional communications. The communication module 840 has at least one antenna to facilitate communication. The communication interface may represent any interface that is necessary for communication with other network elements.

The processor 810 may be of any type suitable to the local technical network and may include one or more of the following: general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

The memory 820 may include one or more non-volatile memories and one or more volatile memories. Examples of the non-volatile memories include, but are not limited to, a Read Only Memory (ROM) 824, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 822 and other volatile memories that will not last in the power-down duration.

A computer program 830 includes computer executable instructions that are executed by the associated processor 810. The program 830 may be stored in the ROM 824. The processor 810 may perform any suitable actions and processing by loading the program 830 into the RAM 822.

The embodiments of the present disclosure may be implemented by means of the program 830 so that the device 800 may perform any process of the disclosure as discussed with reference to FIGS. 2-7. The embodiments of the present disclosure may also be implemented by hardware or by a combination of software and hardware.

In some embodiments, the program 830 may be tangibly contained in a computer readable medium which may be included in the device 800 (such as in the memory 820) or other storage devices that are accessible by the device 800. The device 800 may load the program 830 from the computer readable medium to the RAM 822 for execution. The computer readable medium may include any types of tangible non-volatile storage, such as ROM, EPROM, a flash memory, a hard disk, CD, DVD, and the like. FIG. 9 shows an example of the computer readable medium 900 in form of CD or DVD. The computer readable medium has the program 830 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods 500, 600 and 700 as described above with reference to FIGS. 5, 6 and 7. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-48. (canceled)

49. A first device, comprising:
at least one processor; and
at least one memory including computer program code;
the at least one memory and the computer program code configured to, with the at least one processor, cause the first device to:
detect, at the first device, a beam failure for a serving cell of the first device;
in accordance with a determination that the beam failure is detected for the serving cell, determine whether information related to a beam failure recovery for the serving cell is available;
in accordance with a determination that the information is available, trigger a procedure for the beam failure recovery for the serving cell; and
transmit to a second device a first indication that the beam failure is detected and a second indication as to whether a candidate beam is available.

50. The first device of claim 49, wherein the first device is caused to determine whether the information is available for the serving cell by:
determining whether a searching for a candidate beam for the serving cell is completed;
in accordance with a determination that the searching is not completed, determining that the information is unavailable; and
in accordance with a determination that the searching is completed, determining that the information is available.

51. The first device of claim 50, wherein the first device is caused to transmit the second indication by:
determining whether the candidate beam is found; and
in accordance with a determination that the candidate beam is found, transmitting the second indication that the candidate beam is available, and
wherein the first device is further caused to transmit information about the candidate beam.

52. The first device of claim 51, wherein the first device is caused to determine whether the candidate beam is found by:
in accordance with a determination that no candidate beam is found from a first resource set configured for the searching, continuing the searching in a second resource set configured for the serving cell; and
in accordance with a determination that the candidate beam is found from the second resource set, determining that the candidate beam is found.

53. The first device of claim 52, wherein the first device is caused to continue the searching in the second resource set by:
determining whether a first resource set configured for the searching comprises a second resource set configured for the serving cell; and
in accordance with a determination that the first resource set does not comprise the second resource set, continuing the searching in the second resource set.

54. The first device of claim 50, wherein the first device is further caused to:
cease the searching in response to receiving from the second device information about at least one of the following:
an updated configuration for a reporting of a channel state information measurement,
an updated configuration for a measurement of channel state information,
a condition for a reporting of channel state information, or
a beam indication for a downlink control channel for the serving cell.

55. The first device of claim 50, wherein the first device is caused to determine whether the searching is completed by:
in accordance with a determination that at least one candidate beam is identified within a predetermined period, determining that the search is completed; or
in accordance with a determination that no candidate beam is identified within the predetermined period, determining that the search is completed.

56. A second device, comprising:
at least one processor; and
at least one memory including computer program code;
the at least one memory and the computer program code configured to, with the at least one processor, cause the second device to:
perform, at the second device, at least one of the following:
receiving a first indication that a beam failure for a serving cell of a first device is detected and a second indication that no candidate beam is available, the first and second indications being transmitted by the first device in accordance with a determination that information related to a beam failure recovery for the serving cell is unavailable; or
receiving the first indication that the beam failure is detected and the second indication as to whether a candidate beam is available, the first and second indications being transmitted by the first device in accordance with a determination that the information related to the beam failure recovery for the serving cell is available; and
perform beam management based on the first and second indications.

57. The second device of claim 56, wherein the second device is further caused to:
receive from the first device a third indication as to whether a searching for the candidate beam is completed.

58. The second device of claim 56, wherein the second indication indicates that the candidate beam is available, and
wherein the second device is further caused to receive, from the first device, information about the candidate beam.

59. The second device of claim 56, wherein the second device is further caused to transmit information about at least one of the following to the first device so that a searching for the candidate beam is ceased:
an updated configuration for a reporting of a channel state information measurement;
an updated configuration for a measurement of channel state information,
a condition for a reporting of channel state information; and
a beam indication for a downlink control channel for the serving cell.

60. A method of communication, comprising:
detecting, at a first device, a beam failure for a serving cell of the first device;
in accordance with a determination that the beam failure is detected for the serving cell, triggering a procedure for a beam failure recovery for the serving cell;
determining whether information related to the beam failure recovery is available for the serving cell; and
in accordance with a determination that the information is unavailable, transmitting to a second device a first indication that the beam failure is detected and a second indication that no candidate beam is available.

61. The method of claim 60, further comprising:
in accordance with a determination that the information is unavailable, keeping the procedure for the beam failure recovery for the serving cell triggered.

62. The method of claim 60, wherein determining whether information related to the beam failure recovery is available for the serving cell comprises:
determining whether a searching for a candidate beam for the serving cell is completed;
in accordance with a determination that the searching is not completed, determining that the information is unavailable; and
in accordance with a determination that the searching is completed, determining that the information is available.

63. The method of claim 62, further comprising:
transmitting to the second device a third indication as to whether the searching is completed.

64. The method of claim 62, further comprising:
in accordance with a determination that the information is available, transmitting to the second device the first indication that the beam failure is detected and the second indication as to whether the candidate beam is available.

65. The method of claim 64, wherein transmitting the second indication in accordance with a determination that the information is available comprises:
determining whether the candidate beam is found; and
in accordance with a determination that the candidate beam is found, transmitting the second indication that the candidate beam is available, and
the method further comprising:
transmitting to the second device information about the candidate beam.

66. A method of communication, comprising:
detecting, at a first device, a beam failure for a serving cell of the first device;
in accordance with a determination that the beam failure is detected for the serving cell,
determining whether information related to a beam failure recovery for the serving cell is available; and
in accordance with a determination that the information is available, triggering a procedure for the beam failure recovery for the serving cell; and
transmitting to a second device a first indication that the beam failure is detected and a second indication as to whether a candidate beam is available.

67. The method of claim 66, wherein determining whether the information is available for the serving cell comprises:
determining whether a searching for a candidate beam for the serving cell is completed;
in accordance with a determination that the searching is not completed, determining that the information is unavailable; and
in accordance with a determination that the searching is completed, determining that the information is available.

68. The method of claim 67, wherein transmitting the second indication comprises:
determining whether the candidate beam is found; and
in accordance with a determination that the candidate beam is found, transmitting the second indication that the candidate beam is available, and
the method further comprising:
transmitting, to the second device, information about the candidate beam.
